(19) United States
(12) Patent Application Publication
(10) Pub. No.: US 2025/0291051 A1
(43) Pub. Date: Sep. 18, 2025

(54) SYSTEM AND PROCESSING DEVICE

(71) Applicant: KABUSHIKI KAISHA TOSHIBA, Tokyo (JP)

(72) Inventor: Kazuhiro TSUJIMURA, Kawasaki Kanagawa (JP)

(73) Assignee: KABUSHIKI KAISHA TOSHIBA, Tokyo (JP)

(21) Appl. No.: 19/071,925

(22) Filed: Mar. 6, 2025

(30) Foreign Application Priority Data
Mar. 13, 2024 (JP) 2024-039050

(51) Int. Cl. G01S 13/88; G01S 7/06; G01S 7/35; G01S 7/40; G01S 7/41; G01S 13/90

(52) U.S. Cl. CPC G01S 13/887; G01S 7/062; G01S 7/356; G01S 7/40; G01S 7/417; G01S 13/9004

(57) ABSTRACT

According to one embodiment, a system includes a radar configured to irradiate electromagnetic waves on a target and receive reflected electromagnetic waves from the target, an imaging unit configured to image the target and output target image information, a measurement unit configured to measure a position of the radar, and a processor configured to output first image information representing a first area within the target where the electromagnetic waves are not irradiated based on the position of the radar.

### CROSS-REFERENCE TO RELATED APPLICATIONS

This application is based upon and claims the benefit of priority from Japanese Patent Application No. 2024-039050, filed Mar. 13, 2024, the entire contents of which are incorporated herein by reference.

### FIELD

Embodiments described herein relate generally to a system and a processing device.

### BACKGROUND

In the field of security, a system for inspecting a dangerous object is used. The system irradiates a person with electromagnetic waves and receives reflected electromagnetic waves from a dangerous object hidden in the person's bag or clothes pocket to generate an image of the dangerous object. The irradiation of electromagnetic waves and the reception of reflected electromagnetic waves are referred to as scanning. The system comprises a portable or handheld scanner. A staff points the scanner toward a person and transmits and receives electromagnetic waves to perform a security check.

In order to facilitate the handling of the scanner during the check, it is necessary to make the scanner smaller and lighter. However, if the scanner is made smaller, an antenna aperture length becomes smaller, and the resolution of an image of a dangerous object becomes lower.

The antenna aperture length can be increased by scanning an area corresponding to the field of view of the scanner, then shifting the scanner and repeating the scanning of at least one adjacent area, and generating an image based on reflected electromagnetic waves from a plurality of areas. However, it is challenging for a staff to shift the scanner so that a plurality of areas are scanned without overlap or gaps.

### BRIEF DESCRIPTION OF THE DRAWINGS

FIG. 1 illustrates an example of a system according to a first embodiment.

FIG. 2 illustrates an example of the appearance of a scanner according to the first embodiment.

FIG. 3 illustrates an example of a transmit array antenna and a receive array antenna according to the first embodiment.

FIG. 4 illustrates an example of a transmitter circuit and a receiver circuit according to the first embodiment.

FIG. 5A illustrates an example of a chirp signal according to the first embodiment.

FIG. 5B illustrates an example of the chirp signal according to the first embodiment.

FIG. 6A illustrates an example of an operation of a radar unit according to the first embodiment.

FIG. 6B illustrates an example of an operation of the radar unit according to the first embodiment.

FIG. 6C illustrates an example of an operation of the radar unit according to the first embodiment.

FIG. 7 is a flowchart explaining an example of an operation of a system according to the first embodiment.

FIG. 8 is a flowchart explaining an example of an operation of the system according to the first embodiment.

FIG. 9 is a flowchart explaining an example of an operation of the system according to the first embodiment.

FIG. 10 illustrates an example of a primary scan according to the first embodiment.

FIG. 11 illustrates an example of a first image information according to the first embodiment.

FIG. 12 illustrates an example of specifying an inspection area according to the first embodiment.

FIG. 13 illustrates an example of a virtual array antenna according to the first embodiment.

FIG. 14 illustrates an example of superimposing images according to the first embodiment.

FIG. 15 illustrates an example of a mark on a display according to the first embodiment.

FIG. 16 illustrates an example of a display of a determination result according to the first embodiment.

FIG. 17 illustrates an example of a screen of a display according to the first embodiment.

FIG. 18 illustrates an example of a system according to a second embodiment inspecting a piece of luggage.

### DETAILED DESCRIPTION

Embodiments will be described below with reference to the drawings. In the following descriptions, a device and a method are illustrated to embody the technical concept of the embodiments. The technical concept is not limited to the configuration, shape, arrangement, material or the like of the structural elements described below. Modifications that could easily be conceived by a person with ordinary skill in the art are naturally included in the scope of the disclosure. To make the descriptions clearer, the drawings may schematically show the size, thickness, planer dimension, shape, and the like of each element differently from those in the actual aspect. The drawings may include elements that differ in dimension and ratio. Elements corresponding to each other are denoted by the same reference numeral and their overlapping descriptions may be omitted. Some elements may be denoted by different names, and these names are merely an example. It should not be denied that one element is denoted by different names. Note that “connection” means that one element is connected to another element via still another element as well as that one element is directly connected to another element. If the number of elements is not specified as plural, the elements may be singular or plural.

In general, according to one embodiment, a system comprising a radar configured to irradiate electromagnetic waves on a target and receive reflected electromagnetic waves from the target; an imaging unit configured to image the target and output target image information; a measurement unit configured to measure a position of the radar; and a processor configured to output first image information representing a first area within the target where the electromagnetic waves are not irradiated based on the position of the radar.

### First Embodiment

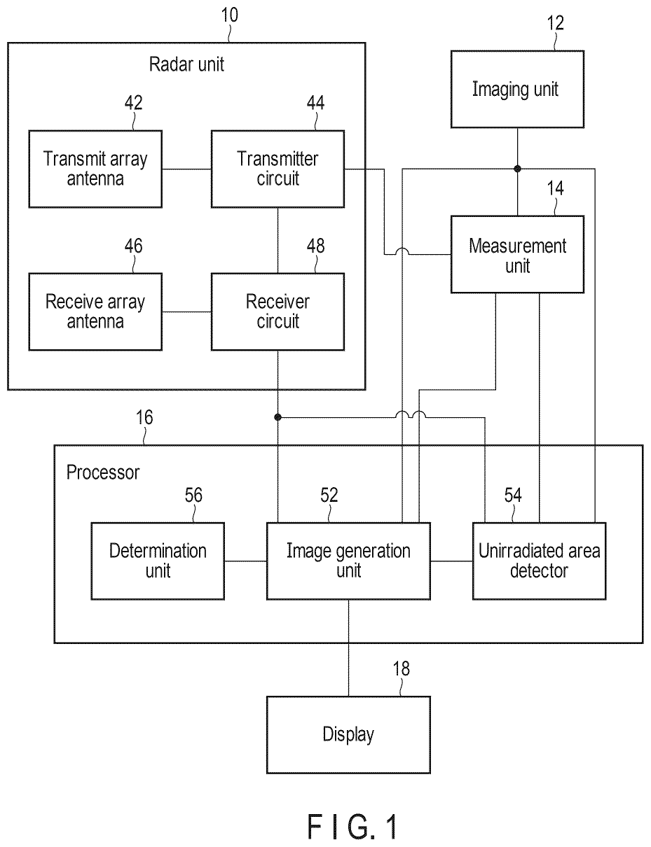

FIG. 1 illustrates an example of a system according to a first embodiment. The system may be used at airports, baseball stadiums, concert halls, etc., for the purpose of counter-terrorism. The system determines whether or not a subject is carrying and hiding a specified object. The specified object may include a dangerous object such as a gun, knife, and explosive, as well as an illegal item such as a drug, which is not permitted to be carried, etc.

The system comprises a radar unit 10, an imaging unit 12, a measurement unit 14, a processor 16, and a display 18. At least the radar unit 10 is implemented as a portable or handheld scanner. A staff has a subject stop for a moment, points the scanner toward the subject, transmits electromagnetic waves to the subject, and receives reflected electromagnetic waves from the subject.

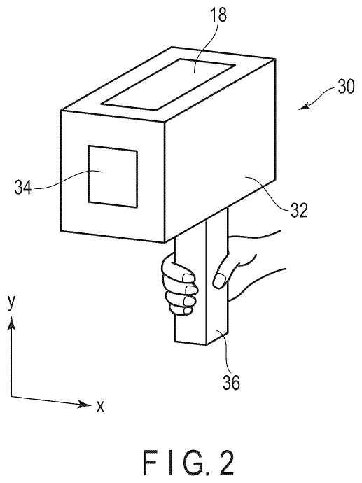

FIG. 2 illustrates an example of the appearance of a scanner 30 according to the first embodiment. The scanner 30 includes a main body 32 and a grip 36. The main body 32 houses at least the radar unit 10. In addition to the radar unit 10, the main body 32 may also house the measurement unit 14 and the processor 16. An electromagnetic wave transmitting/receiving window 34 is made of a material that transmits electromagnetic waves. The electromagnetic wave transmitting/receiving window 34 is disposed on one side (x-y plane) of the main body 32. The display 18 is disposed on a top surface of the main body 32 or on a side surface opposite to the electromagnetic wave transmitting/receiving window 34.

An example of the display 18 is a flat display such as a liquid crystal panel. The display 18 may be a touch panel with input functions. In a case where the display 18 does not comprise input functions, an input device such as a keyboard or mouse is connected to the display 18. The display 18 is not limited to a display disposed on the main body 32, and may be a display that is separate from the main body 32 and connected to the processor 16 by cable or wirelessly. In addition, the display 18 is not limited to a flat display, and may be a head-mounted display connected to the processor 16 by cable or wirelessly. An example of a head-mounted display is an eyeglass-type display or a goggle-type display.

The display 18 displays an image of the subject and an image useful for positioning the scanner 30. By looking at these display images and holding the scanner 30 up to the subject, the staff can scan a plurality of areas without overlap or gaps.

The grip 36 is attached to a lower part of the main unit 32. The staff holds the grip 36 and points the electromagnetic wave transmitting/receiving window 34 of the scanner 30 toward the subject. The grip 36 may comprise a scan start button. When the staff presses the scan start button, the radar unit 10 starts transmitting electromagnetic waves and receiving reflected electromagnetic waves, and the scanner 30 starts scanning. This allows the staff to start scanning at any time. The radar unit 10 transmits and receives electromagnetic waves in an area corresponding to the field of view, and obtains a received signal for each area. The processor 16 generates image information for an object in the area based on the received signal. When scanning of one area is complete, the staff shifts the scanner 30 and presses the scan start button to scan an adjacent area. In a case where the scanner does not comprise a scan start button, the radar unit 10 transmits electromagnetic waves at an arbitrary time interval to perform scanning. Since a portable or handheld scanner 30 is used, inspection can be performed easily.

Returning to the explanation of FIG. 1, the radar unit 10 comprises a transmit array antenna 42, a transmitter circuit 44, a receive array antenna 46, and a receiver circuit 48. The transmitter circuit 44 and the receiver circuit 48 may each be formed by an integrated circuit.

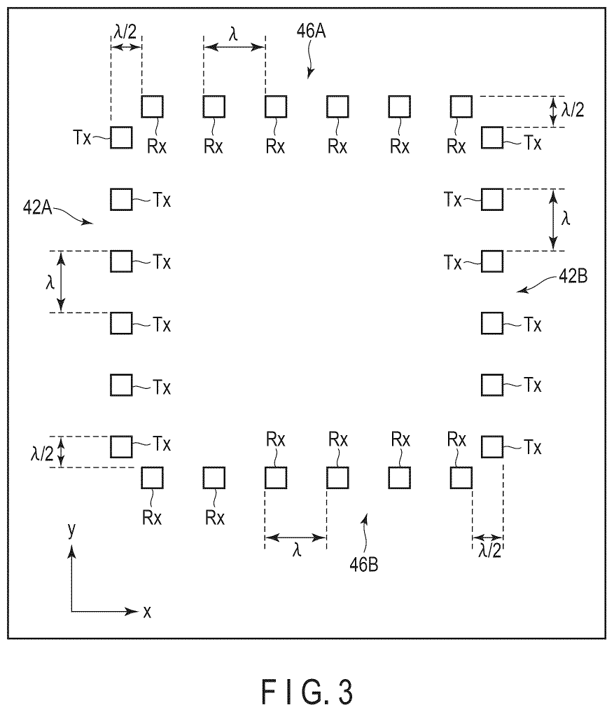

FIG. 3 illustrates an example of the transmit array antenna 42 and the receive array antenna 46 according to the first embodiment.

The transmit array antenna 42 comprises a first transmit array antenna 42A located at a left end of a square area and a second transmit array antenna 42B located at a right end of the square area. The first transmit array antenna 42A comprises a plurality of transmit antennas Tx arranged along a y-axis. The second transmit array antenna 42B comprises a plurality of transmit antennas Tx arranged along the y-axis.

The receive array antenna 46 comprises a first receive array antenna 46A located at an upper end of the square area and a second receive array antenna 46B located at a lower end of the square area. The first receive array antenna 46A comprises a plurality of receive antennas Rx arranged in an x-axis direction. The second receive array antenna 46B comprises a plurality of receive antennas Rx arranged in the x-axis direction.

The array antenna shown in FIG. 3, which is formed by a plurality of transmit antennas Tx and a plurality of receive antennas Rx, is referred to as a multiple-input multiple-output (MIMO) array antenna.

The transmit antennas Tx are arranged at equal intervals, for example, at intervals of wavelength A. The transmit array antenna 42 is an equally spaced array antenna. The receive antennas Rx are arranged at equal intervals, for example, at intervals of wavelength A. The receive array antenna 46 is an equally spaced array antenna. The intervals between the transmit antennas Tx and the receive antennas Rx may be different.

The distance in the y-axis direction between the transmit antenna Tx at the upper end of each of the transmit array antennas 42A and 42B and the first receive array antenna 46A is half the distance of intervals between the transmit antennas Tx (λ/2). The distance in the y-axis direction between the transmit antenna Tx at the lower end of each of the transmit array antennas 42A and 42B and the second receive array antenna 46B is half the distance of intervals between the transmit antennas Tx (λ/2).

The distance in the x-axis direction between the receive antenna Rx at the left end of each of the receive array antennas 46A and 46B and the first transmit array antenna 42A is half the distance of intervals between the receive antennas Rx (λ/2). The distance in the x-axis direction between the receive antenna Rx at the right end of each of the receive array antennas 46A and 46B and the second transmit array antenna 42B is half the distance of intervals between the receive antennas Rx (λ/2).

The equally spaced array antenna can receive waves reflected in multiple directions from objects within an irradiated area, with less reception leakage.

Each of the transmit array antenna 42 and the receive array antenna 46 may be an unequally spaced array antenna comprising a plurality of antennas arranged at unequal intervals. Furthermore, each of the transmit array antenna 42 and the receive array antenna 46 may be a minimum redundancy array (MRA) antenna. In the MRA antenna, antennas are arranged at unequal intervals, and the unequal intervals include several intervals. The unequal intervals include, for example, an interval that is m1 times a wavelength and an interval that is m2 times a wavelength, where m1 and m2 are mutually prime. By using the MRA antenna, the number of antennas forming an array antenna can be reduced, an aperture length can be increased efficiently, and high resolution can be achieved in image generation by synthetic aperture processing.

Returning to the explanation of FIG. 1, the transmitter circuit 44 is connected to the transmit array antenna 42 (first transmit array antenna 42A and second transmit array antenna 42B). The receiver circuit 48 is connected to the receive array antenna 46 (first receive array antenna 46A and second receive array antenna 46B).

Although not shown in FIG. 1, the transmitter circuit 44 may comprise a first transmitter circuit and a second transmitter circuit. The first transmitter circuit is connected to the first transmit array antenna 42A. The second transmitter circuit is connected to the second transmit array antenna 42B. The receiver circuit 48 may comprise a first receiver circuit and a second receiver circuit. The first receiver circuit connected to the first receive array antenna 46A. The second receiver circuit is connected to the second receive array antenna 46B. Each of the first transmitter circuit and the second transmitter circuit may comprise a plurality of transmitter circuits. Each of the transmitter circuits may be connected to a plurality of transmit antennas in the transmit array antenna 42. Each of the first receiver circuit and the second receiver circuit may comprise a plurality of receiver circuits. Each of the receiver circuits may be connected to a plurality of receive antennas in the receive array antenna 46. The numbers of transmit array antennas 42 and transmitter circuits 44 and the numbers of receive array antennas 46 and receiver circuits 48 may be set arbitrarily.

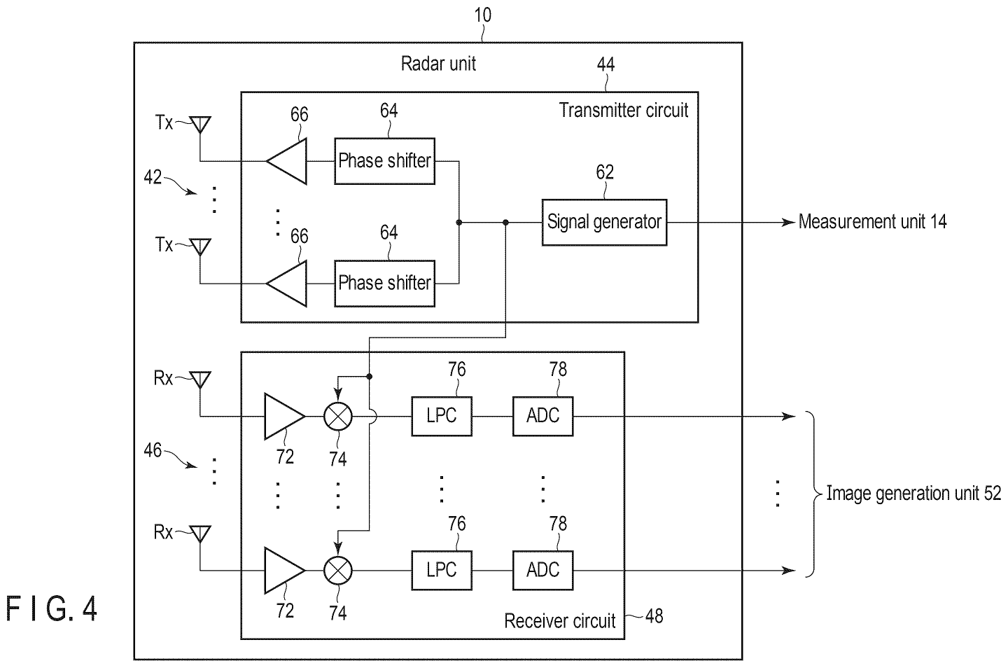

FIG. 4 illustrates an example of the transmitter circuit 44 and the receiver circuit 48 according to the first embodiment. The transmitter circuit 44 comprises a signal generator 62. The radar unit 10 adopts a linear frequency modulated continuous wave (L-FMCW) method in which a frequency linearly increases with the passage of time. The signal generator 62 generates an L-FMCW signal (also referred to as a chirp signal). The signal generator 62 generates the chirp signal using a reference signal, an RF synthesizer, and a frequency multiplier.

The chirp signal output from the signal generator 62 is supplied to the transmit antennas Tx via a plurality of phase shifters 64 and a plurality of transmit amplifiers 66, respectively. The chirp signal is also supplied to the receiver circuit 48. A phase shifter 64 adjusts a phase of a transmission signal. A transmit amplifier 66 adjusts a transmission power.

The transmitter circuit 44 may transmit the chirp signal sequentially from one transmit antenna, or may transmit the chirp signal simultaneously from a plurality of transmit antennas.

The receiver circuit 48 includes a plurality of receive amplifiers 72, a plurality of mixers 74, a plurality of low-pass filters (LPF) 76, and a plurality of A/D converters (ADC) 78. A plurality of received signals output from the receive antennas Rx are supplied to first input terminals of the mixers 74 via the receive amplifiers 72, respectively. The chirp signal is supplied to second input terminals of the mixers 74.

The mixers 74 multiply the received signals and the chirp signal and generate a plurality of received intermediate frequency (IF) signals, respectively. The received IF signals each output from the mixers 74 are supplied to an image generation unit 52 via the LPFs 76 and the ADCs 78, respectively.

The radar unit 10 causes all of the receive antennas Rx to simultaneously receive reflected waves of electromagnetic waves transmitted from one transmit antenna Tx, and repeats this process for all of the transmit antennas Tx to execute one scan.

The signal generator 62 transmits a start pulse to the measurement unit 14 at the time of transmitting the chirp signal, that is, at the time when the radar unit 10 starts one scan.

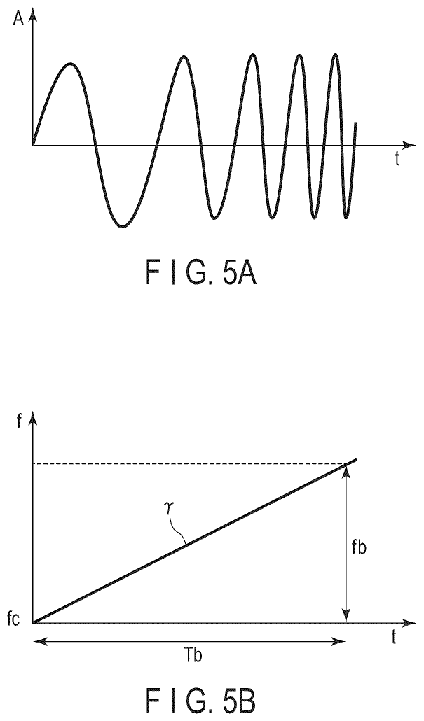

FIGS. 5A and 5B illustrate an example of the chirp signal according to the first embodiment. FIG. 5A shows the chirp signal in which amplitude A is expressed as a function of time t. FIG. 5B shows the chirp signal in which frequency f is expressed as a function of time t. As shown in FIG. 5B, the chirp signal is expressed by a center frequency fc, a modulation bandwidth fb, and a signal time width Tb. The slope of the chirp signal is referred to as a frequency change rate (chirp rate) Y.

A transmission radar signal St(t) of the chirp signal is expressed by Equation 1.

$$St ( t ) = cos [ 2 π ( fc \times t + γ {t}^{2} / 2 ) ] \qquad Equation 1$$

A chirp rate γ is expressed by Equation 2.

$$γ = fb / Tb \qquad Equation 2$$

A reflected wave from an object that is a distance R away from the radar unit 10 is observed with a delay of Δt=2R/c from the transmission timing. C is the speed of light. A received signal Sr (t) is expressed by Equation 3, assuming the reflection intensity of the object is “a”.

$$Sr ( t ) = a \times cos [ 2 n π c ( t - Δ t ) + π {γ ( t - Δ t )}^{2} ] \qquad Equation 3$$

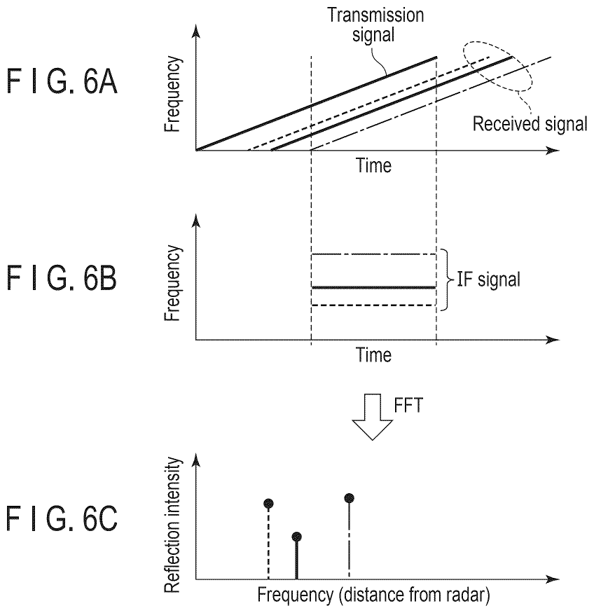

FIGS. 6A, 6B, and 6C illustrate an example of an operation of the radar unit 10 according to the first embodiment. FIGS. 6A, 6B, and 6C show the principle of detecting objects in a case where there are a plurality of objects, for example three objects. FIG. 6A shows the relationship between a transmission signal and time, and the relationship between a received signal and time. As shown in FIG. 6A, the frequency of the transmission signal (chirp signal) changes linearly with time. The received signal is delayed by Δt relative to the transmission signal. In a case where there are a plurality of objects, a reflected wave from a nearest object, indicated by broken lines, is received first, and a reflected wave from a farthest object, indicated by dotted-dashed lines, is received last.

As shown in FIG. 4, the received signal is multiplied by the chirp signal at the mixer 74 to become a received IF signal z(t). The received IF signal z(t) is expressed by Equation 4.

$$z ( t ) = a \times cos ( 2 πΔ t γ t ) \qquad Equation 4$$

FIG. 6B shows the relationship between the frequency and time of a received IF signal. In an ideal environment with no noise, etc., the frequency is constant for each reflected wave. The frequency of the received IF signal of the reflected wave from the nearest object, indicated by the broken lines, is the lowest, and the frequency of the received IF signal of the reflected wave from the farthest object, indicated by the dotted-dashed lines, is the highest.

The reflection intensity in a frequency domain can be calculated by the processor 16 performing a fast Fourier transform (FFT) on the received IF signal z(t) in a time domain expressed by Equation 4. Therefore, an amplitude of the received IF signal z(t) at each point in the frequency domain, which is the result of the FFT of the received IF signal, corresponds to the reflection intensity for each distance from the radar unit 10. A frequency f_{if} and a distance R has the relationship expressed by Equation 5.

$${f}_{if} = Δ t γ = 2 R γ / c \qquad Equation 5$$

The relationship between the reflection intensity and frequency obtained by FFT of the received IF signal in the time domain is shown in FIG. 6C. As shown, by obtaining the amplitude of a frequency domain signal of the received IF signal, it is possible to obtain the reflection intensity for each distance from the radar unit 10.

As the electromagnetic waves used in the embodiment, electromagnetic waves with a wavelength of 1 to 30 millimeters may be used. Electromagnetic waves with a wavelength of 1 to 10 millimeters are referred to as millimeter waves. Electromagnetic waves with a wavelength of 10 to 100 millimeters are referred to as microwaves. Furthermore, electromagnetic waves with a wavelength of 100 micrometers to 1 millimeter may be used as electromagnetic waves used in the embodiment. Electromagnetic waves with a wavelength of 100 micrometers to 1 millimeter are referred to as terahertz waves.

These electromagnetic waves are reflected by a subject's skin. These electromagnetic waves are also reflected by metal objects such as guns and knives. The reflectivity of metal is higher than that of skin. The intensity of the reflected wave from metal is higher than that of the reflected wave from skin. These electromagnetic waves are absorbed by powdered substances such as explosives. The reflectivity of powder is lower than that of skin. The intensity of the reflected waves is determined by an object located at a reflection point of the electromagnetic waves, such as skin, metal, or powder. Therefore, the type of object located at the reflection point can be determined from the intensity of the reflected waves.

Returning to the explanation of FIG. 1, the imaging unit 12 comprises an optical sensor such as a camera. The system defines an inspection area in which the subject is located during scanning. The field of view of the imaging unit 12 is larger than the field of view of the radar unit 10. The field of view of the imaging unit 12 corresponds to an entire body of the subject, for example. The imaging unit 12 is installed so that its field of view includes the entire body of the subject located in the inspection area. When the subject enters the inspection area, the imaging unit 12 takes a single image of the subject's entire body. The subject does not need to remain still during imaging. The imaging unit 12 can also image a subject in motion. The imaging unit 12 supplies one piece of subject image information to the measurement unit 14 and the processor 16.

The measurement unit 14 is connected to the radar unit 10, the imaging unit 12, and the processor 16. In response to a start pulse from the transmitter circuit 44, the measurement unit 14 determines the position of the scanner 30 when the radar unit 10 irradiates electromagnetic waves. The measurement unit 14 may determine the position of the scanner 30 (specifically, the radar unit 10) using a self-position estimation method based on a subject image output by the imaging unit 12. The position is a relative position with respect to the subject. The relative position is expressed in terms of coordinates in a coordinate system of the target image information. The measurement unit 14 obtains the position of the scanner 30 in real time in addition to the position of the scanner 30 at the start of electromagnetic wave irradiation.

The measurement unit 14 may obtain the position using the self-position estimation method described in “Visual odometry”, D. Nister, O. Naroditsky and J. Bergen, Proceedings of the 2004 IEEE Computer Society Conference on Computer Vision and Pattern Recognition, 2004. CVPR 2004., Washington, DC, USA, 2004, pp. I-I, doi: 10.1109/CVPR.2004.1315094. The measurement unit 14 may comprise a gyro sensor and determine the position of the scanner 30 based on an output of the gyro sensor. The measurement unit 14 supplies the position of the scanner 30 to the processor 16.

The processor 16 is connected to the radar unit 10, the imaging unit 12, the measurement unit 14, and the display 18. The processor 16 comprises an image generation unit 52, an unirradiated area detector 54, and a determination unit 56. Output signals of the imaging unit 12, the receiver circuit 48, and the measurement unit 14 are supplied to the image generation unit 52. The output signals of the imaging unit 12 and the measurement unit 14 are supplied to the unirradiated area detector 54.

The unirradiated area detector 54 detects a first area (referred to as an unirradiated area) and a second area (referred to as an irradiated area) in the subject based on the position of the radar unit 10 and the field of view of the radar unit 10 when it has irradiated the electromagnetic waves. Electromagnetic waves have not been irradiated to the first area. Electromagnetic waves have been irradiated to the second area. For the portion of the subject irradiated with electromagnetic waves, the unirradiated area detector 54 may determine, as the irradiated area, an area defined by the field of view of the radar unit 10, which is an area that falls within the field of view of all transmit antennas and the field of view of all receive antennas. Alternatively, the unirradiated area detector 54 may determine an area that falls within the field of view of some of the transmit antennas and the field of view of some of the receive antennas as the irradiated area.

The unirradiated area detector 54 obtains the unirradiated area by excluding the irradiated area from the entire area of the subject. The unirradiated area detector 54 may detect an irradiated area in which the level of the received signal is equal to or lower than a specified level as the unirradiated area, rather than as the irradiated area. Therefore, the output signal of the receiver circuit 48 is also supplied to the unirradiated area detector 54.

The unirradiated area detector 54 supplies coordinates of the contour of the irradiated area and coordinates of the contour of the unirradiated area to the image generation unit 52. The coordinates of the irradiated area and the unirradiated area are the coordinates in the coordinate system of the subject image information.

The output signal of the unirradiated area detector 54 is supplied to the image generation unit 52. The image generation unit 52 generates first image information representing the irradiated area and unirradiated area based on the image of the irradiated area and the coordinates of the unirradiated area. The first image information may be image information representing only the unirradiated area. Here, the first image information is assumed to be image information representing the irradiated area and unirradiated area.

The image generation unit 52 supplies the subject image information and the first image information to the display 18. The display 18 displays a first image based on the first image information superimposed on the subject image based on the subject image information. The first image includes an irradiated area image and an unirradiated area image. The display 18 may display the irradiated area image and the unirradiated area image as a rectangle (either filled or hatched) indicating the entire area, or as a frame indicating the outline of the area. The display 18 may display the unirradiated area image in a hue, brightness, or saturation that differs from that of the irradiated area image. The display 18 may display one of the irradiated area images and the unirradiated area image continuously, and the other by blinking. This allows the staff to easily recognize the irradiated area and the unirradiated area of the subject.

The image generation unit 52 also generates second image information that represents the area to be scanned by the scanner 30, i.e., the area to be irradiated with electromagnetic waves by the radar unit 10 (hereinafter referred to as the planned irradiation area), based on the real-time position of the scanner 30 output from the measurement unit 14. The image generation unit 52 also supplies the second image information to the display 18. The display 18 displays a second image based on the second image information. The display 18 may display the second image as a rectangle (which may be filled or hatched) indicating the entire planned irradiation area, or as a frame indicating the outline of the planned irradiation area. The display 18 may display the second image as a frame including a perspective view of the scanner 30. The display 18 may display the second image in a hue, brightness, or saturation that differs from that of the first image (the irradiated area image and/or the unirradiated area image). The display 18 may display one of the first image and the second image continuously, and the other by blinking. This allows the staff to easily recognize the irradiated area and the planed irradiation area of the subject.

The display 18 may display the first image and the second image superimposed on the subject image. This allows the staff to position the second image on the unirradiated area image in a manner that the scanner 30 scans the unirradiated area, and to easily position the scanner 30.

The image generation unit 52 also generates object image information of a specified object hidden by the subject based on the output signal of the receiver circuit 48. The image generation unit 52 supplies the object image information to the display 18. The display 18 displays an object image, based on the object image information, superimposed on the subject image. This allows the staff to determine whether or not the subject is in possession of the specified object based on the image.

The image generation unit 52 comprises a buffer memory that stores the subject image information, the first image information, the second image information, and the object image information.

The determination unit 56 determines whether or not the subject is in possession of the specified object based on the object image information. The image generation unit 52 supplies the subject image information, the object image information, and a determination result to the display 18. The display 18 displays the determination result in addition to the subject image and the object image. A display example of the determination result is a text indicating the specified object. This allows the staff to easily determine whether or not the subject is in possession of the specified object. A manner of output of the determination result is not limited to display, and may also include the generation of an alarm sound or vibration of the scanner 30.

The image generation unit 52, the unirradiated area detector 54, and the determination unit 56 may be realized respectively by a plurality of hardware blocks, or may be realized in software by one or more CPUs. For example, the processor 16 may be realized by one or more processing circuits such as a CPU, a microprocessor, a graphics processing unit (GPU), an application specific integrated circuit (ASIC), and a field-programmable gate array (FPGA), or an electronic circuit including these circuits. The processor 16 may be realized by a computer or other information processing device, a computer system formed by a plurality of computers or servers communicating with each other via a network, or a PC cluster in which a plurality of computers cooperates to execute information processing, etc. Instead of comprising a single CPU, the processor 16 may comprise a plurality of CPUs, each of which realizes at least part of a plurality of functions.

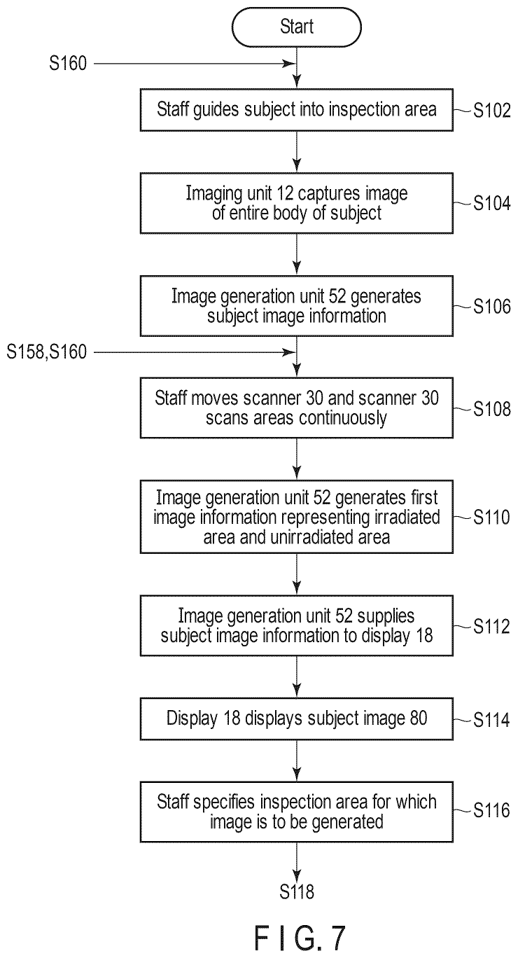

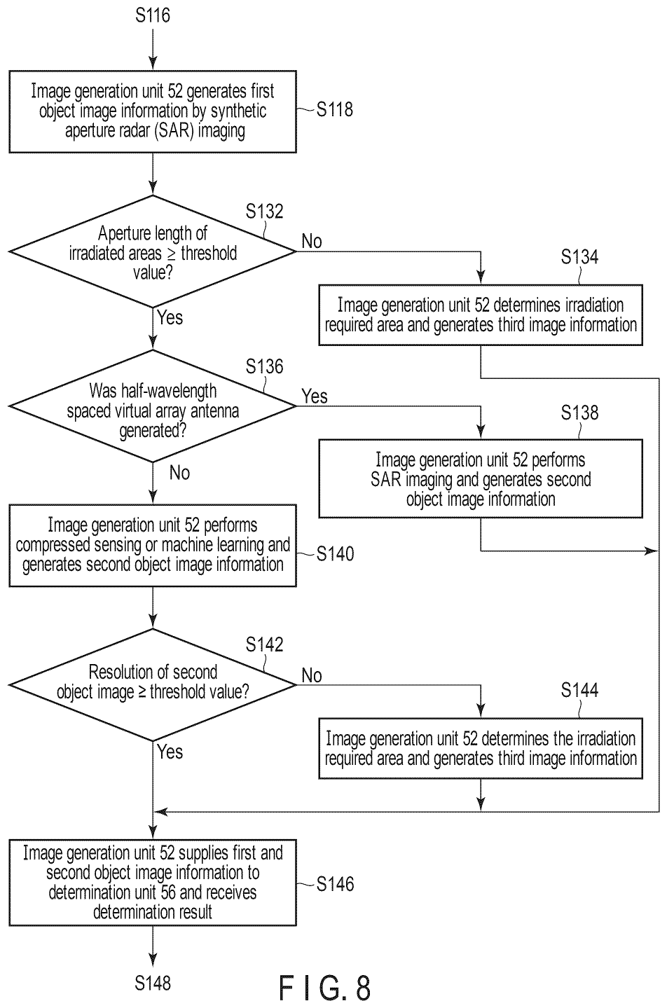

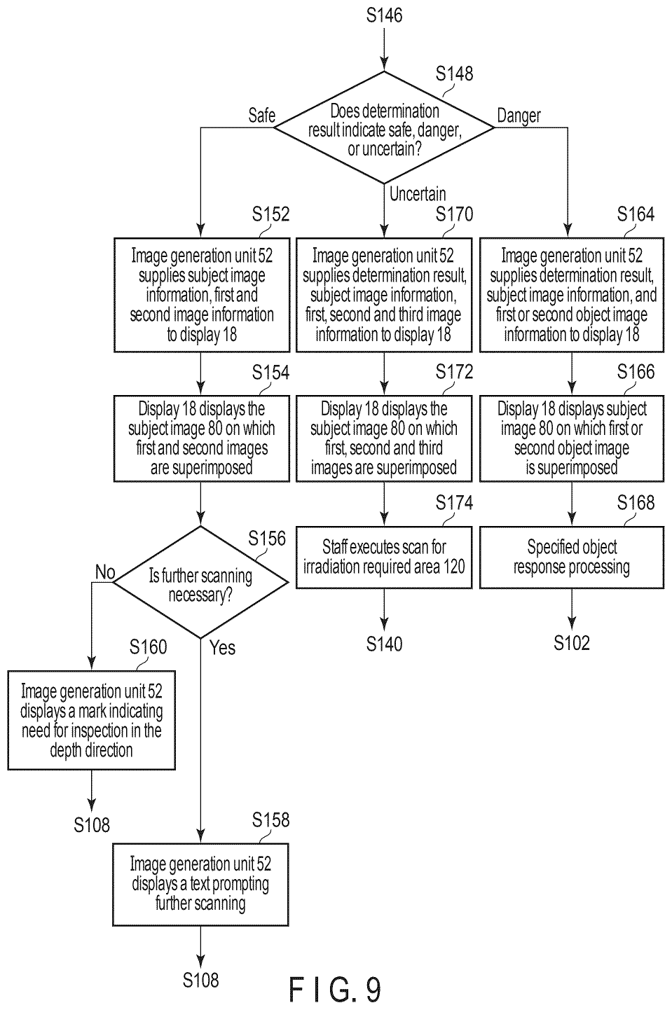

FIG. 7 is a first part of a flowchart explaining an example of an operation of a system according to the first embodiment. FIG. 8 is a middle part of the flowchart explaining the example of the operation of the system according to the first embodiment. FIG. 9 is a last part of the flowchart explaining the example of the operation of the system according to the first embodiment.

A staff guides a subject into an inspection area (S102). The imaging unit 12 captures an image of the entire body of the subject in the inspection area (S104). The image generation unit 52 generates subject image information (S106).

The staff moves the scanner 30. While moving, the scanner 30 transmits electromagnetic waves to the subject and receives electromagnetic waves from the subject, and scans a plurality of areas continuously (S108). The staff can move the scanner 30 as desired. In the first embodiment, there is a possibility of scanning the subject twice. The scanning in S108 is a first scan, and is referred to as a primary scan. The receiver circuit 48 supplies a received signal to the image generation unit 52.

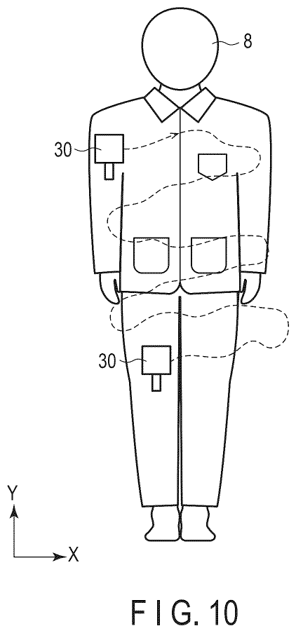

FIG. 10 illustrates an example of the primary scan according to the first embodiment executed in S108. FIG. 10 shows a trajectory of the scanner 30 when the staff scans a subject 8 almost entirely with the scanner 30. During scanning, the radar unit 10 irradiates electromagnetic waves in an irradiated area corresponding to the field of view, and receives reflected electromagnetic waves from the irradiated area. The field of view depends on the number of antennas forming a transmit array antenna and the number of antennas forming the receive array antenna (aperture length). The image generation unit 52 generates an image of the object at a reflection point based on the received signal. The resolution of the image depends on the aperture length. To increase the aperture length of the radar unit 10, it is sufficient to generate an image of the object based on the reflected electromagnetic waves from a plurality of irradiated areas. The irradiated areas need to be arranged in a grid pattern. However, because the hand movements of the staff may meander and the movement speed may vary, it is difficult for the irradiated areas to be adjacent in a grid pattern without gaps or overlaps.

The image generation unit 52 generates first image information representing the irradiated area and the unirradiated area based on a signal from the unirradiated area detector 54 (S110).

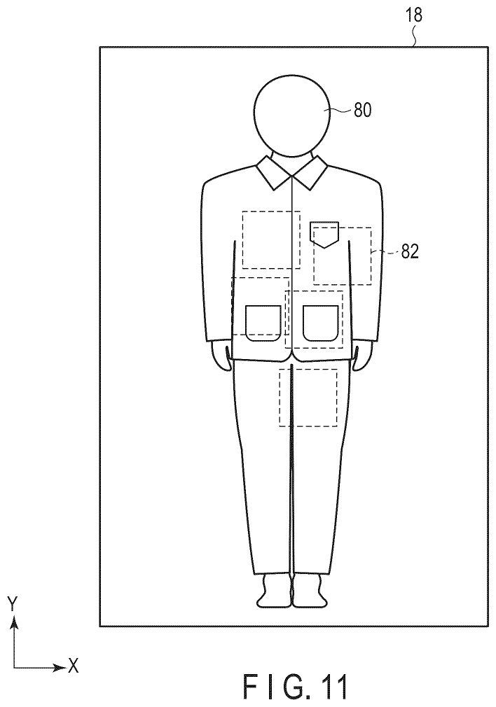

FIG. 11 illustrates an example of the first image information according to the first embodiment that is generated in S110. As a result of the primary scan, a plurality of irradiated areas 82 are set in a subject image 80. A gap may occur between one irradiated area 82 and the surrounding irradiated areas 82. In addition, two adjacent irradiated areas 82 may partially overlap each other. A part of the subject image 80 other than the irradiated areas 82 is the unirradiated area.

The image generation unit 52 supplies the subject image information generated in S106 to the display 18 (S112). The display 18 displays the subject image 80 based on the subject image information (S114).

The staff specifies an inspection area for which an image is to be generated in order to determine whether or not a specified object is present in the subject image 80 (S116).

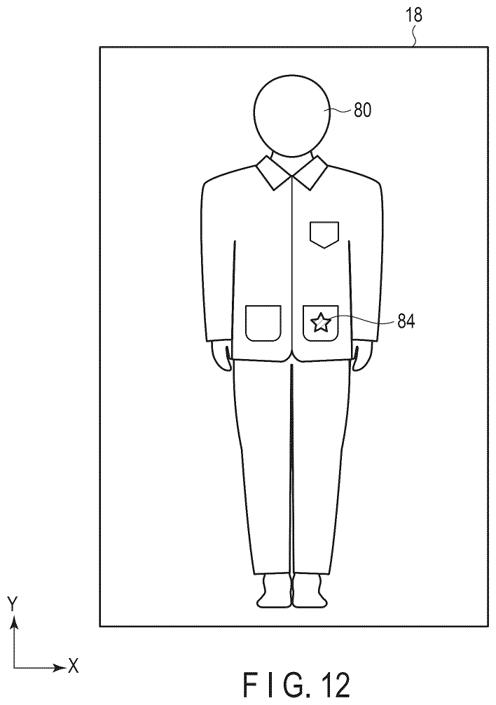

FIG. 12 illustrates an example of specifying an inspection area according to the first embodiment in S116. When specifying an inspection area, the image generation unit 52 generates a pointer 84 for specifying an inspection target, and displays the pointer 84 superimposed on the subject image 80 on the display 18. An example of the pointer 84 is a star mark.

The staff changes the position of the pointer 84 and sets the pointer 84 to a part of the subject where the specified object is likely to be hidden, for example, in a pocket. An area of a predetermined size centered on the pointer 84 is specified as the inspection area. The predetermined size may be narrower than the irradiated area.

The image generation unit 52 generates object image information of the inspection area based on an output signal of the receiver circuit 48. The image generation unit 52 can generate the object image information from received signals of a plurality of irradiated areas, and, also, from received signals of a plurality of adjacent irradiated areas in order to improve the resolution.

The image generation unit 52 executes two types of imaging: low-resolution imaging and high-resolution imaging. First, the image generation unit 52 generates first object image information by synthetic aperture radar (SAR) imaging based on the received signals for a plurality of irradiated areas (S118). The image generation unit 52 generates the first object image information by synthesizing a plurality of images based on the received signals of a plurality of irradiated areas. The SAR imaging that generates the first object image information is also referred to as the low-resolution imaging.

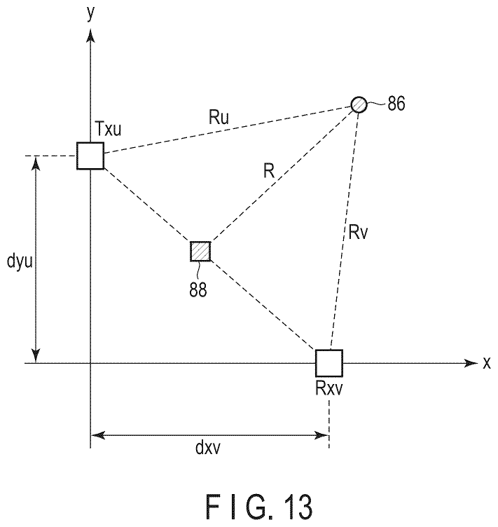

The image generation unit 52 generates a virtual array antenna from the MIMO array antenna shown in FIG. 3 and generates the first object image information based on the virtual array antenna. FIG. 13 illustrates an example of the virtual array antenna according to the first embodiment. A virtual antenna 88 is generated by a u-th transmit antenna Txu and a v-th receive antenna Rxv. The virtual antenna 88 is generated on a straight line connecting the transmit antenna Txu and the receive antenna Rxv. The distance in the x-axis direction between the transmit antenna Txu and the receive antenna Rxv is dxv. The distance in the y-axis direction between the transmit antenna Txu and the receive antenna Rxv is dyu. The path length between a target 86 and the transmit antenna Txu is Ru. The path length between the target 86 and the receive antenna Rxv is Rv. The path length between the target 86 and the virtual antenna 88 is R.

A plurality of virtual antennas 88 generated by a combination of all the transmit antennas Tx and all the receive antennas Rx are arranged at equal intervals in both the x-axis and y-axis directions, and form an equally spaced virtual array antenna. Alternatively, the virtual antennas 88 may be arranged at unequal intervals in both the x-axis and y-axis directions, and may form an unequally spaced virtual array antenna.

The image generation unit 52 performs imaging using range migration algorithm (RMA) for the virtual array antenna shown in FIG. 13. An example of the RMA imaging is described in “Near-Field MIMO-SAR Millimeter-Wave Imaging with Sparsely Sampled Aperture Data”, M. E. Yanik and M. Torlak, in IEEE Access, vol. 7, pp. 31801-31819, 2019. The antenna arrangement of the array antenna, the method of generating the virtual array antenna, and the imaging examples are not limited to the examples described in this specification.

First, RMA imaging using a single (mono static) transmit/receive antenna that can be used for both transmission and reception is explained. Then, an example of developing a single transmit/receive antenna into a MIMO antenna is explained.

A modulation method of the radar unit 10 is FMCW method, and a transmission radar signal St is expressed by Equation 6.

$${s}_{t} ( t ) = exp ( j 2 π ( {f}_{C} t + \frac{γ}{2} {t}^{2} ) ) \qquad Equation 6$$

f_{C} is the center frequency and γ is the chirp rate. Here, the received signal at the receive antenna Rx is expressed by Equation 7.

$${s}_{r} ( t ) = σ exp ( j 2 π ( {f}_{C} ( t - τ ) + \frac{γ}{2} {( t - τ )}^{2} ) ) \qquad Equation 7$$

τ is the arrival time of the reflected wave from the target 86 to the receive antenna Rx (δt in Equation 3). σ is a reflection coefficient (a in Equation 3). The received IF signal is expressed by Equation 8.

$$s ( t ) = σ exp ( j 2 π ( {f}_{C} τ + γτ t + \frac{γ}{2} {t}^{2} ) ) \qquad Equation 8$$

A third term of an exponential term in Equation 8 is called a residual video phase and is known to be negligible. If a time width of FMCW pulse of the chirp signal is T, Equation 8 can be rewritten as Equation 9. K is a wave number.

$$s ( k ) = σ {e}^{j 2 kR} , \frac{2 π {f}_{C}}{C} \leq k \leq \frac{2 π ( {f}_{C} + γ T )}{C} \qquad Equation 9$$

In a case where a reflected electromagnetic wave from the target 86 located at (x, y, z0) is received by the receive antenna Rx located at (x′, y′, 0), the received wave s is expressed as expressed by Equation 10.

$$s ( {x}^{′} , {y}^{′} , k ) = \int \int \int σ ( x , y , z ) {e}^{j 2 kR} dxdydz \qquad Equation 10$$

When performing a plane wave expansion of Equation 10 with respect to exp (j2kR), Equation 11 is obtained.

$$s ( {x}^{′} , {y}^{′} , k ) = \int \int {\underbrace{\int \int σ ( x , y ) {e}^{- j ( {k}_{x} x + {k}_{y} y )} dxdy}}_{\sum ( {k}_{x} , {k}_{y} )} \times {e}^{j ( {k}_{x} {x}^{′} + {k}_{y} {y}^{′} + {k}_{z} {z}_{0} )} {dk}_{x} {dk}_{y} \qquad Equation 11$$

Σ is a two-dimensional Fourier transform of the reflection coefficient σ. Since the double integral is an inverse Fourier transform, Equation 11 can be rewritten as Equation 12.

$$s ( {x}^{′} , {y}^{′} , k ) = {ℱ}_{2 D}^{- 1} [ \sum ( {k}_{x} , {k}_{y} ) {e}^{{jk}_{z} {z}_{0}} ] \qquad Equation 12$$

From Equation 12, the reflection coefficient σ can be obtained as expressed by Equation 13. Once the reflection coefficient σ is obtained, the target 86 is imaged.

$$σ ( x , y ) = {ℱ}_{2 D}^{- 1} [ {ℱ}_{2 D} [ s {x}^{′} , {y}^{′} , k ) ] {e}^{j {k}_{Z} {z}_{0}} ] \qquad Equation 13$$

Next, RMA imaging using the MIMO array antenna is explained. Here, imaging is performed using a virtual array antenna that includes the virtual antenna 88 generated from the transmit antenna Tx and the receive antenna Rx. A path length R_{u, v} from the transmit antenna Tx to the receive antenna Rx via the target 86 is expressed by Equation 14.

$${R}_{u , v} = {R}_{u} + {R}_{v} = \sqrt{{( {x}_{u} - x )}^{2} + {( {y}_{u} - y )}^{2} + {z}_{0}^{2}} + \sqrt{{( {x}_{v} - x )}^{2} + {( {y}_{v} - y )}^{2} + {z}_{0}^{2}} \qquad Equation 14$$

When Taylor expansion of the path length is performed, Equation 15 is obtained.

$${R}_{u , v} \approx 2 R + \frac{{( {d}_{u , v}^{x} )}^{2} + {( {d}_{u , v}^{y} )}^{2}}{4 R} \qquad Equation 15$$

A second term of Equation 15 is a difference ΔR between the path length R_{u, v} related to the transmit/receive antenna and a path length R related to a virtual array. If the propagation path length difference ΔR is corrected as in Equation 16, it can be used as a received signal by a single transmit/receive antenna. The division of ΔR in the exponential term of Equation 16 corresponds to the correction. In the MIMO array antenna, the transmit antenna and the receive antenna are separate; however, this correction makes it possible to approximate the received signal with the path length of the single transmit/receive antenna.

$$s ( {x}_{u , v} , {y}_{u , v} , k ) = \int \int σ ( x , y ) {e}^{jk ( {R}_{u , v} - Δ R )} dxdy \qquad Equation 16$$

By using Equation 16 in RMA processing using the single transmit/receive antenna, it is possible to perform imaging of the MIMO array antenna.

Resolutions δx and δy in the x-axis and y-axis directions of a first object image obtained by this imaging are expressed by Equations 17 and 18. Dx and Dy are aperture lengths in the x-axis and y-axis directions of the MIMO array antenna formed by the transmit array antenna 42 and the receive array antenna 46.

$${δ}_{x} \approx \frac{λ {z}_{0}}{2 {D}_{x}} \qquad Equation 17$$

$${δ}_{y} \approx \frac{λ {z}_{0}}{2 {D}_{y}} \qquad Equation 18$$

Equations 17 and 18 show that in order to obtain a high resolution, it is sufficient to increase the aperture lengths Dx and Dy. When the staff moves the scanner 30 by hand, it is difficult to move it accurately to a millimeter-level precision of the electromagnetic wave wavelength. In the first embodiment, as will be described later, during a secondary scan, an irradiation required area is superimposed on a target image and displayed, which allows the staff to correctly position the scanner 30 and scan a desired area.

Returning to the explanation of the flowchart, the image generation unit 52 executes high-resolution imaging based on the received signals of a set of plurality of irradiated areas set in the primary scan. First, it is determined whether or not the aperture length of the irradiated areas relating to high-resolution imaging is greater than or equal to a threshold value (S132). The threshold value is determined based on the resolution required for the image of the object to be inspected.

In a case where the aperture length of the irradiated areas is less than the threshold value (No in S132), the image generation unit 52 determines the irradiated area (referred to as the irradiation required area) required to achieve the aperture length corresponding to the required resolution, and generates third image information representing the irradiation required area (S134). The irradiation required area is selected from among the unirradiated areas. The third image information is stored in the buffer memory of the image generation unit 52.

In a case where the aperture length is greater than or equal to the threshold value (Yes in S132), the image generation unit 52 determines whether or not an equally spaced virtual array antenna of half a wavelength (half-wavelength spaced virtual array antenna) was generated in the SAR imaging of S118 (S136). In a case where the half-wavelength spaced virtual array antenna was generated (Yes in S136), the image generation unit 52 performs the SAR imaging based on the received signals from the irradiated areas and generates second object image information (S138). By performing the SAR imaging using the received signals from the irradiated areas, the aperture length is increased, and high resolution is achieved. The resolution of the second object image information is higher than the resolution of the first object image information based on the received signal of a single irradiated area.

In a case where the half-wavelength spaced virtual array antenna is not generated (No in S136), the image generation unit 52 performs imaging using compressed sensing or machine learning and generates the second object image information (S140). Examples of compressed sensing are described in “Near-Filed 3-D Synthetic Aperture Radar Imaging via Compressed Sensing”, Z. Yang, Y. R. Zheng, ICASSP, pp. 2513-2516, 2012 and “Proximal algorithms”, N. Parikh and S. Boyd, Foundations and Trends in Optimization, vol. 1, no. 3, pp. 123-231, 2013. Examples of machine learning is described in “RMIST-Net: Joint Range Migration and Sparse Reconstruction Network for 3-D mmW Imaging”, M. Wang et al., in IEEE Transactions on Geoscience and Remote Sensing, vol. 60, pp. 1-17, 2022.

The image generation unit 52 determines whether or not the resolution of a second object image based on the second object image information generated in S140 is greater than or equal to a threshold value (S142). The threshold value of the resolution in S142 is higher than the resolution corresponding to the threshold value of the aperture length in S132.

In a case where an image quality of the second object image is less than the threshold value (No in S142), the image generation unit 52 determines the irradiation required area to achieve the aperture length corresponding to the resolution corresponding to the threshold value, and generates third image information representing the irradiation required area (S144).

In a case where the resolution of the second object image is greater than or equal to the threshold value (Yes in S142), or after executing S134, S138, and S144, the image generation unit 52 supplies the first object image information and the second object image information to the determination unit 56 and receives a determination result from the determination unit 56 (S146). The determination unit 56 determines the state of the subject based on the first object image information and the second object image information.

The image generation unit 52 determines whether the determination result indicates safe, danger, or uncertain (S148).

In a case where the determination result indicates safe, the image generation unit 52 supplies the subject image information, the first image information, and the second image information to the display 18 (S152). The display 18 displays the subject image 80 based on the subject image information, on which the first image based on the first image information and the second image based on the second image information are superimposed (S154).

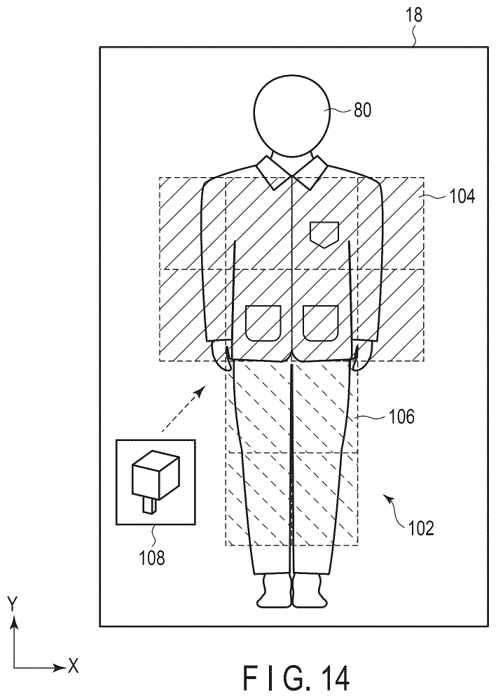

FIG. 14 illustrates an example of superimposing and displaying the subject image 80, the first image, and the second image by the display 18 according to the first embodiment in S154. The display 18 displays an image in which a first image 102 and a second image 108 are superimposed on the subject image 80.

The first image 102 includes squares arranged in a two-dimensional array. The size of the squares is the same as the size of the irradiated area corresponding to the field of view of the radar unit 10. The squares include an irradiated area or areas (the area or areas hatched with solid lines) 104 and an unirradiated area or areas (the area or areas hatched with broken lines) 106.

The second image 108 includes a frame showing the outline of the planned irradiation area and a perspective view of the scanner 30. The size of the outline of the planned irradiation area is the same as the size of a square included in the first image 102.

The staff looks at the first image 102 (FIG. 14) displayed on the display 18 and recognizes that the lower half of the subject's body is an unirradiated area, i.e., an uninspected area. The staff inputs to the image generation unit 52 via an input device (not shown) whether or not to scan the unirradiated area. The image generation unit 52 determines whether or not further scanning is necessary based on this input (S156).

In a case where further inspection is necessary (Yes in S156), the image generation unit 52 displays a text prompting further scanning by superimposing it on the display image (FIG. 14) of the display 18 (S158). The staff easily positions the scanner 30 by aligning the frame (planned irradiation area) of the second image 108 with one of the unirradiated areas 106 while looking at the display image of the display 18. Subsequently, the staff executes a primary scan for the unirradiated area 106 (S108). This allows additional inspection of area that was not inspected in the initial primary scan.

The areas (irradiated area, unirradiated area, and inspection area) described above are areas related to the x-y plane. The inspection of an object is an inspection of whether or not the object is present in the x-y plane. The presence or absence of the object in a plane perpendicular to the x-y plane, such as a y-z plane or an x-z plane, is not inspected. When the subject is carrying and hiding a specified object, it is possible that the object is placed between one's arms or legs. This object will be detected in the y-z plane because it has a certain area in the y-z plane, but in the x-y plane it is recognized only as a point or a line, and may not have a certain area.

The image generation unit 52 performs image recognition on the subject image 80. In a case where the subject image 80 in the x-y plane includes an armpit or armpits or crotch extending in a depth direction (z-axis direction), the image generation unit 52 displays a mark on the display 18 indicating the need for inspection in the depth direction, and prompts the staff to perform further inspection (S160). In addition to or instead of the mark, the image generation unit 52 may display a text prompting further inspection.

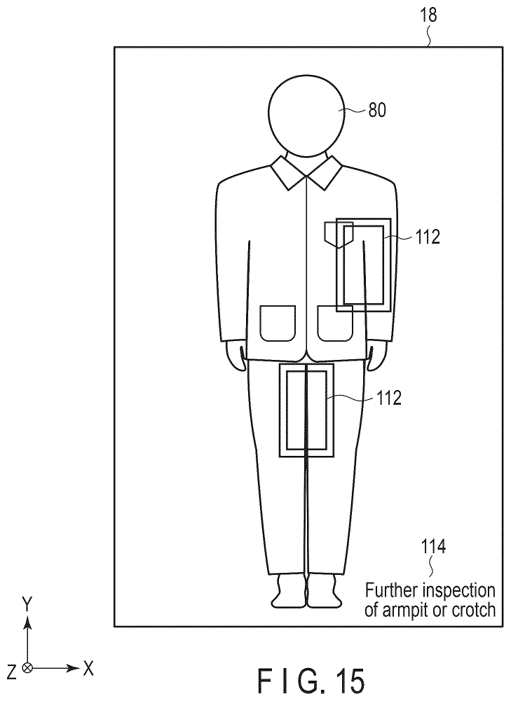

FIG. 15 illustrates an example of a mark 112 indicating the need for a depth direction inspection by the display 18 according to the first embodiment in S160. FIG. 15 shows an example of displaying the mark 112 superimposed on the subject image 80, as well as displaying a text 114 indicating the need for further inspection of the armpit or crotch.

The staff follows the display of S160 and executes the primary scan of the area including the armpit or crotch while the subject is in a state of opening his/her arms or legs apart (S108). This allows an object for which an image cannot be formed by the received signals from the irradiated areas of a single plane (x-y plane) to be inspected.

In a case where the determination result indicates danger, the image generation unit 52 supplies the determination result, the subject image information, and the first object image information or the second object image information to the display 18 (S164). The display 18 displays the subject image 80 based on the subject image information, on which the first object image based on the first object image information or the second object image based on the second object image information is superimposed, together with the determination result (S166).

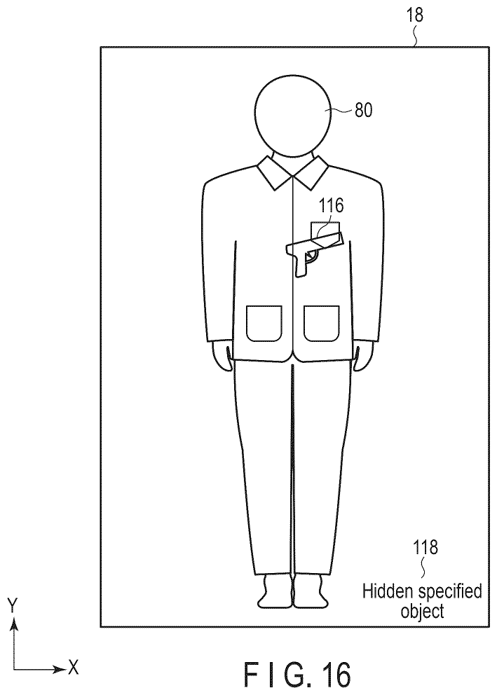

FIG. 16 illustrates an example of the display of the determination result by the display 18 according to the first embodiment in S166. The display 18 displays the subject image 80 on which a first or second object image 116 is superimposed, together with a text 118 showing the determination result.

The staff looks at the display shown in FIG. 16 and realizes that there is a possibility that the subject has a hidden specified object such as a gun. The staff executes specified object response processing (S168). Examples of the specified object response processing include generating an alarm sound and requesting backup from security guards. The staff then guides a next subject into the inspection area (S102). This ensures that a subject carrying specified objects is detected.

In a case where the determination result indicates uncertain, the image generation unit 52 supplies the determination result, the subject image information, the first image information, the second image information, and the third image information to the display 18 (S170). The display 18 displays the subject image 80 based on the subject image information on which the first image based on the first image information, the second image based on the second image information, and a third image based on the third image information are superimposed (S172).

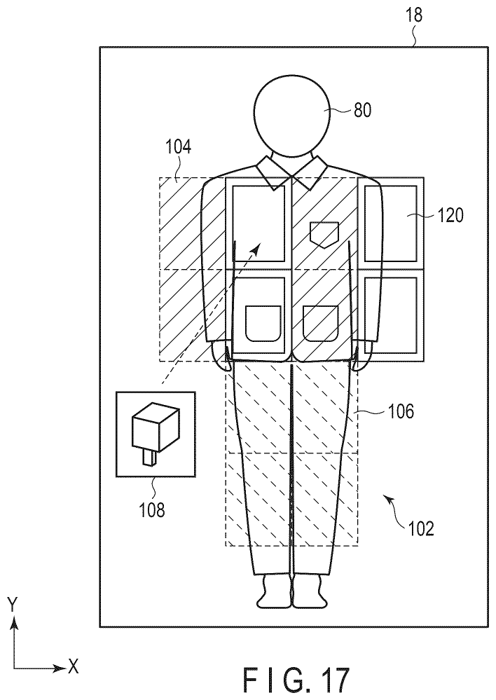

FIG. 17 illustrates an example of the screen of the display 18 according to the first embodiment in S172. The display 18 displays the subject image 80 on which the first image 102, the second image 108, and a third image (irradiation required area or areas) 120 are superimposed (S172).

The staff can easily position the scanner 30 by aligning the frame (planned irradiation area) of the second image 108 with one of the irradiations required areas 120 while looking at the screen in FIG. 17. Subsequently, the staff executes a scan for the irradiations required area 120 (S174). The scan in S174 is the second scan for the same subject, and is referred to as the secondary scan. After the secondary scan in S174, the image generation unit 52 performs imaging using compressed sensing or machine learning to generate the second object image information (S140).

As a result, in a case where the aperture length of the irradiated areas set in the primary scan in S108 is less than a required size and the determination result is uncertain, the irradiation required area to achieve a required aperture length is accurately scanned in the secondary scan. Alternatively, in a case where the resolution of the second object image obtained by imaging using compressed sensing or machine learning in S140 is less than a required resolution and the determination result is uncertain, the irradiation required area is accurately scanned in the secondary scan to achieve the required resolution. In this manner, the scan is divided into the primary and secondary scans. The primary scan is realized easily and quickly. Only the area that could not be inspected in the primary scan is inspected in the secondary scan.

According to the first embodiment, when the staff scans the subject while moving the scanner 30, even if an unirradiated portion occurs, the display image shows the unirradiated area or irradiation required area. The staff can position the scanner 30 so as to re-scan the unirradiated area while looking at this display, thereby eliminating the unirradiated area. SAR imaging is performed based on the received signals from the irradiated areas, and a high-resolution object image is generated. Therefore, a system and a processing device that can execute accurate inspection in a short time are provided.

### Second Embodiment

The inspection target of the first embodiment is a human. The inspection target is not limited to humans, and can also be animals or suspicious objects.

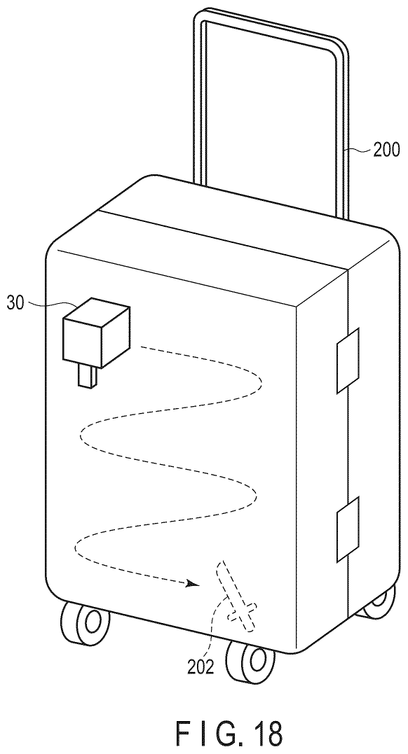

FIG. 18 illustrates an example of a system according to a second embodiment inspecting a piece of luggage (suitcase). As in the first embodiment, a staff scans a suitcase 200 from the outside using a scanner 30.

The second embodiment is effective for non-destructive inspection of hand luggage and suspicious boxes. The configuration of the second embodiment is the same as that of the first embodiment. The processing flow of the second embodiment is almost the same as that of the first embodiment. In the flowcharts of FIG. 7, FIG. 8, and FIG. 9, the subject is replaced by an object, and guiding the subject into the inspection area in S102 is replaced by placing the object in the inspection area.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising:
a radar configured to irradiate electromagnetic waves on a target and receive reflected electromagnetic waves from the target;
an imaging unit configured to image the target and output target image information;
a measurement unit configured to measure a position of the radar; and
a processor configured to output first image information representing a first area within the target where the electromagnetic waves are not irradiated based on the position of the radar.

2. The system of claim 1, wherein the processor is configured to generate the first image information based on the position of the radar when the radar irradiates the electromagnetic wave.

3. The system of claim 1, wherein the radar comprises a transmit antenna, the transmit antenna comprising an equally spaced array antenna, an unequally spaced array antenna, or a minimum redundancy array antenna.

4. The system of claim 1, wherein the radar comprises a receive antenna, the receive antenna comprising an equally spaced array antenna, an unequally spaced array antenna, or a minimum redundancy array antenna.

5. The system of claim 1, wherein the measurement unit is configured to measure the position of the radar using an output signal of a gyro sensor or the target image information.

6. The system of claim 1 further comprising a display configured to display a target image and a first image, the target image being based on the target image information, and the first image being based on the first image information.

7. The system of claim 6, wherein an operation period of the system includes:
a primary scan period in which the radar irradiates the electromagnetic waves on an arbitrary area of the target; and
a secondary scan period in which the radar irradiates the electromagnetic waves on the first area after the first image information is output.

8. The system of claim 7, wherein a display mode of the display includes:
a first display mode in which the first image is not displayed; and
a second display mode in which the first image is displayed.

9. The system of claim 8, wherein
the display mode of the display is the first display mode during the primary scan period; and
after the primary scan period, the display mode of the display is changed from the first display mode to the second display mode.

10. The system of claim 6, wherein the processor is configured to generate object image information representing a specified object in the target using reflected electromagnetic waves from at least one area.

11. The system of claim 10, wherein the display is configured to display an object image based on the object image information by superimposing the object image on the target image.

12. The system of claim 6, wherein
the processor is configured to determine whether or not the target contains the specified object using reflected electromagnetic waves from at least one area; and
the display is configured to display a determination result as to whether or not the target contains the specified object.

13. The system of claim 6, wherein the display comprises a flat display, an eyeglass-type display, or a goggle-type display.

14. The system of claim 6, wherein
the target image information is two-dimensional image information in a first surface; and
the first area includes an area in the first surface within the target where the electromagnetic waves are not irradiated, and an area in a second surface perpendicular to the first surface within the target where the electromagnetic waves are not irradiated.

15. The system of claim 14, wherein the processor is configured to cause the display to display a text prompting irradiation of the electromagnetic waves from the radar on the area in the second surface where the electromagnetic waves are not irradiated.

16. The system of claim 6, wherein
the processor is configured to determine a planned irradiation area within the target based on the position of the radar and generate a second image representing the planned irradiation area; and
the display is configured to display the target image, the first image, and the second image.

17. The system of claim 6, wherein the display is configured to display the first image continuously or in a blinking manner with a specific hue, brightness, or saturation.

18. The system of claim 6, wherein
the processor is configured to output second image information representing a second area within the target where electromagnetic waves are irradiated; and
the display is configured to display the target image by superimposing the first image based on the first image information and the second image based on the second image information on the target image as a rectangle indicating an entire area or a frame indicating an outline of an area.

19. The system of claim 6, wherein
the processor is configured to output second image information representing a second area within the target where electromagnetic waves are irradiated; and
the display is configured to display a first image based on the first image information on the target image in a hue, brightness, or saturation different from a second image based on the second image information.

20. The system of claim 6, wherein
the processor is configured to output second image information representing a second area within the target where electromagnetic waves are irradiated; and
the display is configured to
display one of a first image based on the first image information and a second image based on the second image information continuously on the target image, and
display another of the first image and the second image based on the second image information on the target image by blinking.

21. A processing device connected to a radar, an imaging unit, and a measurement unit; the radar configured to irradiate electromagnetic waves on a target and receive reflected electromagnetic waves from the target; the imaging unit configured to image the target and output target image information; and the measurement unit configured to measure a position of the radar, the processing device is configured to output first image information representing a first area within the target where the electromagnetic waves are not irradiated based on the position of the radar.
